(19) United States
(12) Patent Application Publication
(10) Pub. No.: US 2026/0158630 A1
(43) Pub. Date: Jun. 11, 2026

(54) POWERED FASTENER DRIVER

(71) Applicant: MILWAUKEE ELECTRIC TOOL CORPORATION, Brookfield, WI (US)

(72) Inventors: Marcus M. Wechselberger, Milwaukee, WI (US); David A. Bierdeman, New Berlin, WI (US); Logan M. Hietpas, Glendale, WI (US); Jeremy J. Keifenheim, West Bend, WI (US)

(21) Appl. No.: 19/410,353

(22) Filed: Dec. 5, 2025

Related U.S. Application Data
(60) Provisional application No. 63/728,950, filed on Dec. 6, 2024.

(51) Int. Cl. B25C 1/04; B25C 1/00

(52) U.S. Cl. CPC B25C 1/041; B25C 1/001

(57) ABSTRACT

A powered fastener driver includes a housing defining a cylinder support portion and a handle portion. The cylinder support portion includes a first side and a second side opposite the first side. The handle portion extends from the first side of the cylinder support portion. The cylinder support portion includes a flat segment on the second side configured to support the powered fastener driver on a support surface in an inverted position with the handle portion extending away from the support surface. A cylinder is within the cylinder support portion. A nosepiece extends from the housing and includes a fastener driving channel through which consecutive fasteners are driven. The fastener driving channel extends along a driving axis. A magazine is coupled to the nosepiece and is configured to consecutively deliver the fasteners to the fastener driving channel.

### CROSS-REFERENCE TO RELATED APPLICATIONS

This application claims priority to U.S. Provisional Patent Application No. 63/728,950 filed on Dec. 6, 2024, the entire content of which is incorporated herein by reference.

### FIELD OF THE INVENTION

The present invention relates to powered fastener drivers, and more specifically to gas spring-powered fastener drivers.

### BACKGROUND OF THE INVENTION

There are various fastener drivers known in the art for driving fasteners (e.g., nails, tacks, staples, etc.) into a workpiece. These fastener drivers operate utilizing various means known in the art (e.g., compressed air generated by an air compressor, electrical energy, a flywheel mechanism, etc.), but often these designs are met with power, size, and cost constraints.

### SUMMARY OF THE INVENTION

In some aspects, the techniques described herein relate to a powered fastener driver including: a housing defining a cylinder support portion and a handle portion, the cylinder support portion including a first side and a second side opposite the first side, the handle portion extending from the first side of the cylinder support portion, the cylinder support portion including a flat segment on the second side configured to support the powered fastener driver on a support surface in an inverted position with the handle portion extending away from the support surface; a cylinder within the cylinder support portion; a nosepiece extending from the housing and including a fastener driving channel through which consecutive fasteners are driven, the fastener driving channel extending along a driving axis; and a magazine coupled to the nosepiece and configured to consecutively deliver the fasteners to the fastener driving channel.

In some aspects, the techniques described herein relate to a powered fastener driver including: a housing defining a cylinder support portion and a handle portion, the cylinder support portion including a first side and a second side opposite the first side, the handle portion extending from the first side of the cylinder support portion; a cylinder within the cylinder support portion; a nosepiece extending from the housing and including a fastener driving channel through which consecutive fasteners are driven, the fastener driving channel extending along a driving axis, the nosepiece including a nosepiece base, and a nosepiece cover defining the fastener driving channel therebetween, wherein the nosepiece cover is movable relative to the nosepiece base between a closed position and an open position; a latch mechanism releasably coupling the nosepiece cover to the nosepiece base, the latch mechanism adjustable between a latched state and a released state; and a magazine coupled to the nosepiece and configured to consecutively deliver the fasteners to the fastener driving channel, wherein a portion of the second side of the housing and a portion of the latch mechanism collectively define a planar surface that is configured to support the powered fastener driver on a support surface in an inverted position with the handle portion extending away from the support surface.

In some aspects, the techniques described herein relate to a powered fastener driver including: a housing defining a cylinder support portion and a handle portion, the cylinder support portion including a first side and a second side opposite the first side, the handle portion extending from the first side of the cylinder support portion, the cylinder support portion including a planar surface on the second side configured to support the powered fastener driver on a support surface in an inverted position with the handle portion extending away from the support surface; a cylinder within the cylinder support portion; a nosepiece extending from the housing and including a fastener driving channel through which consecutive fasteners are driven, the fastener driving channel extending along a driving axis; and a magazine coupled to the nosepiece and configured to consecutively deliver the fasteners to the fastener driving channel, wherein a plane defined by the planar surface is positioned at an oblique angle relative to the driving axis. Other features and aspects of the invention will become apparent by consideration of the following detailed description and accompanying drawings.

### BRIEF DESCRIPTION OF THE DRAWINGS

FIG. 1A is a perspective view of a gas spring-powered fastener driver including a nosepiece, a magazine, a latch mechanism, and a workpiece contact element in accordance with an embodiment of the invention.

FIG. 1B is a side view of the gas spring-powered fastener driver of FIG. 1A.

FIG. 2 is another perspective view of the gas spring-powered fastener driver of FIG. 1A.

FIG. 3 is a side view of the gas spring-powered fastener driver of FIG. 1A in an inverted position.

FIG. 4A is a cross-sectional view of the gas spring-powered fastener driver of FIG. 1A along the line 4A-4A of FIG. 1A.

FIG. 4B is a cross-sectional view of the gas spring-powered fastener driver of FIG. 1A along the line 4B-4B of FIG. 1A.

FIG. 4C is a cross-sectional view of the gas spring-powered fastener driver of FIG. 1A along the line 4C-4C of FIG. 4B.

FIG. 5 is a perspective view of the gas spring-powered fastener driver of FIG. 1A with portions removed for clarity.

FIG. 6 is a perspective view of a frame and the nosepiece of the gas spring-powered fastener driver of FIG. 1A, illustrating the nosepiece in a closed position and a latch mechanism of the nosepiece in a latched state.

FIG. 7 is another perspective view of the frame and nosepiece of the gas spring-powered fastener driver of FIG. 6, illustrating the nosepiece in the closed position and the latch mechanism of the nosepiece in the latched state.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

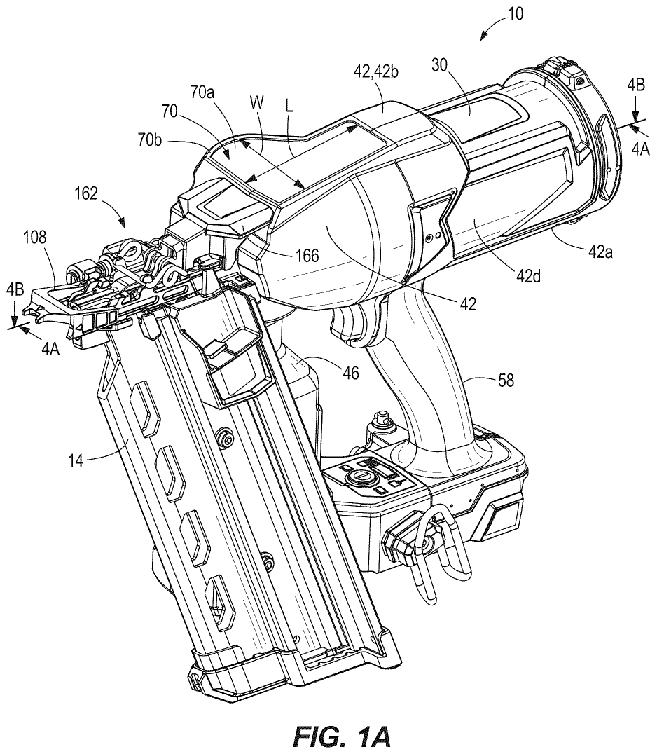

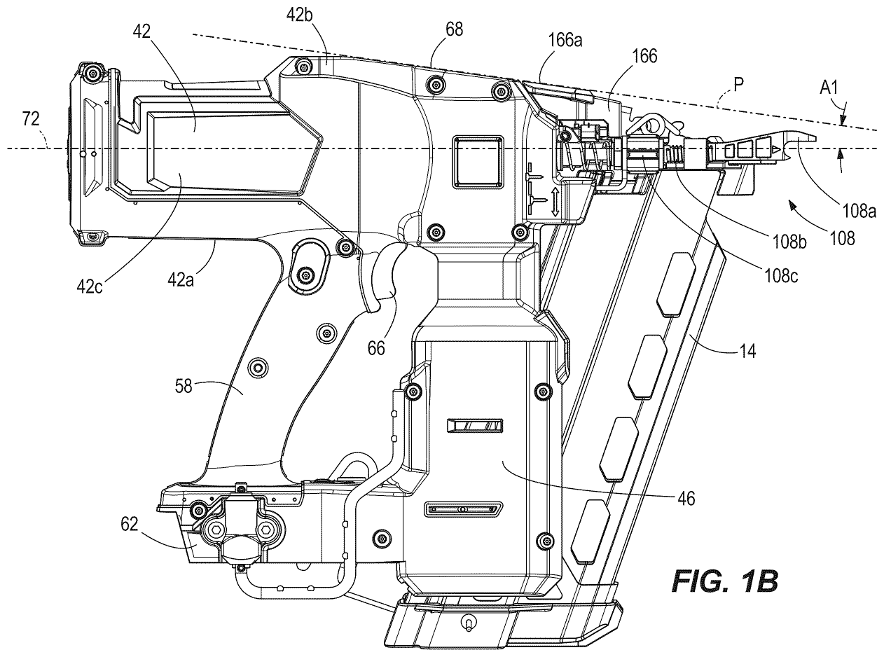

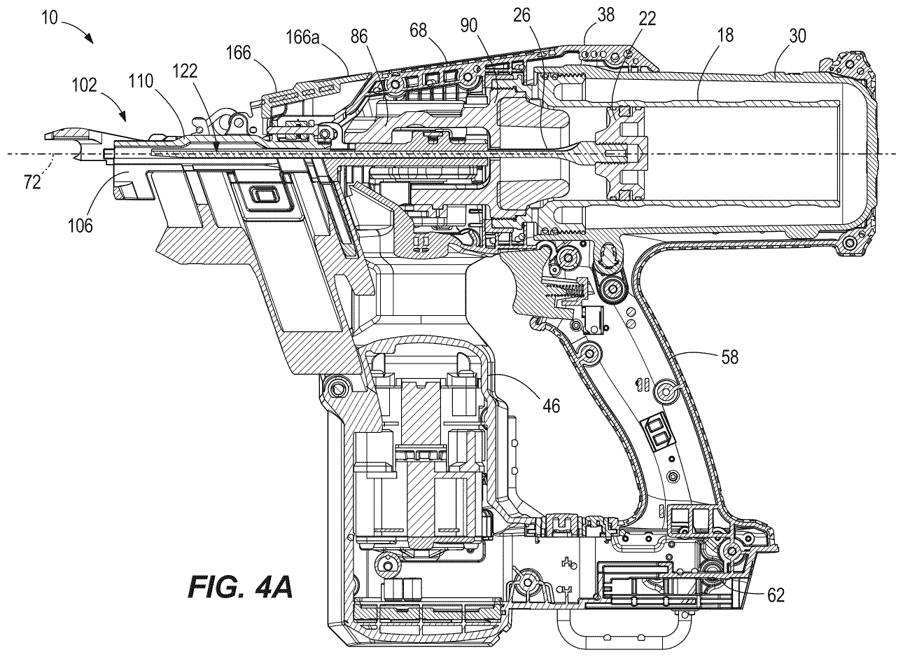

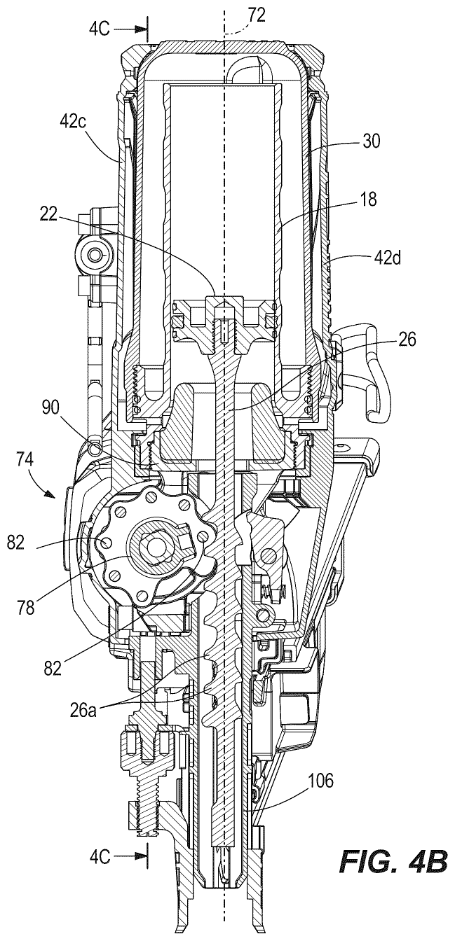

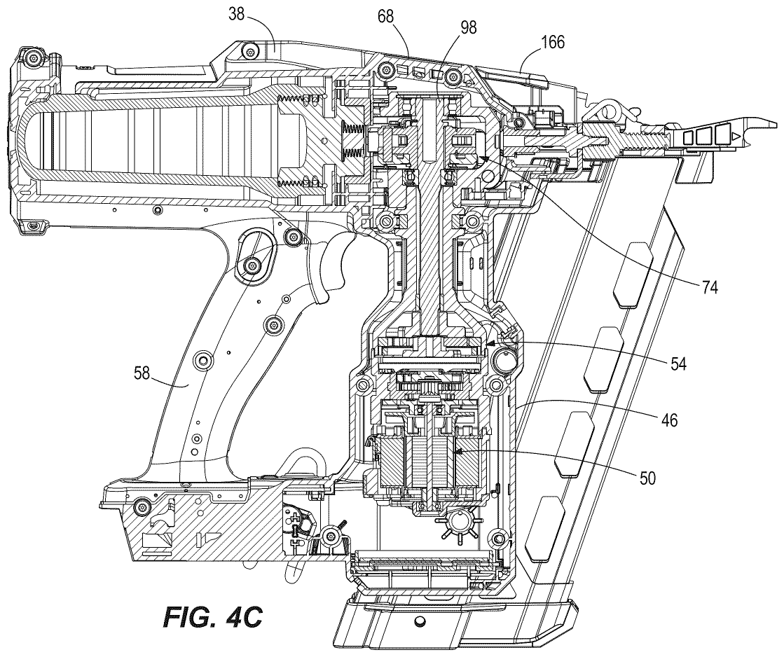

With reference to FIGS. 1A-5, a gas spring-powered fastener driver 10 is operable to drive fasteners (e.g., nails, tacks, staples, etc.) held within a magazine 14 into a workpiece. The fastener driver 10 includes an inner cylinder 18 and a moveable piston 22 positioned within the inner cylinder 18 (FIGS. 4A-4B). With reference to FIGS. 4A and 4B, the fastener driver 10 further includes a driver blade 26 that is attached to the piston 22 and moveable therewith. The fastener driver 10 does not require an external source of air pressure, but rather includes an outer storage chamber cylinder 30 of pressurized gas in fluid communication with the inner cylinder 18. In the illustrated embodiment, the inner cylinder 18 and moveable piston 22 are positioned within the storage chamber cylinder 30. The driver 10 further includes a fill valve (not shown) coupled to the storage chamber cylinder 30. When connected with a source of compressed gas, the fill valve permits the storage chamber cylinder 30 to be refilled with compressed gas if any prior leakage has occurred. The fill valve may be configured as a Schrader valve, for example.

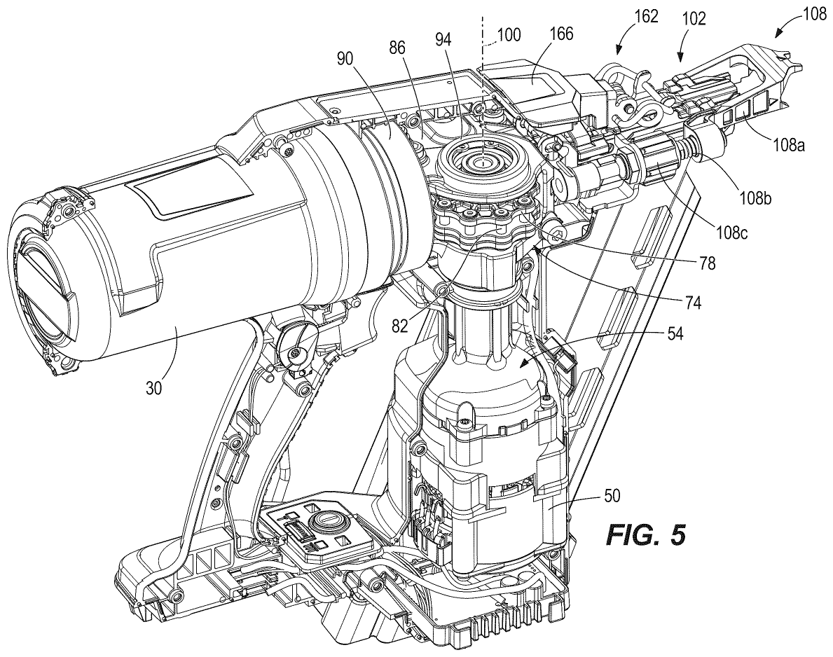

With reference to FIG. 5, the fastener driver 10 includes a housing 38 having a cylinder support portion 42 and a drive unit support portion 46 extending therefrom. The cylinder support portion 42 is configured to support the cylinders 18, 30, whereas the drive unit support portion 46 is configured to support a motor 50 and a transmission 54 operatively coupled to the motor 50. In the illustrated embodiment, the housing 38 includes two clamshell halves coupled to one another. The cylinder support portion 42 includes a first side 42a, a second side 42b opposite the first side 42a, a third side 42c, and a fourth side 42d opposite the third side 42c. In the illustrated embodiment, the drive unit support portion 46 extends laterally from the third side 42c of the cylinder support portion 42. As shown, a height of the drive unit support portion 46 extends from the second side 42b to a location that is spaced apart from the first side 42a.

The housing 38 further includes a handle portion 58 extending from the cylinder support portion 42, and a battery attachment portion 62 coupled to an opposite end of the handle portion 58. In the illustrated embodiment, the handle portion 58 extends from the first side 42a of the cylinder support portion 42. A battery pack (not shown) is electrically connectable to the motor 50 for supplying electrical power to the motor 50. The handle portion 58 supports a trigger 66, which is depressed by a user to initiate a firing cycle of the fastener driver 10. The handle portion 58 is spaced apart from the drive unit support portion 46.

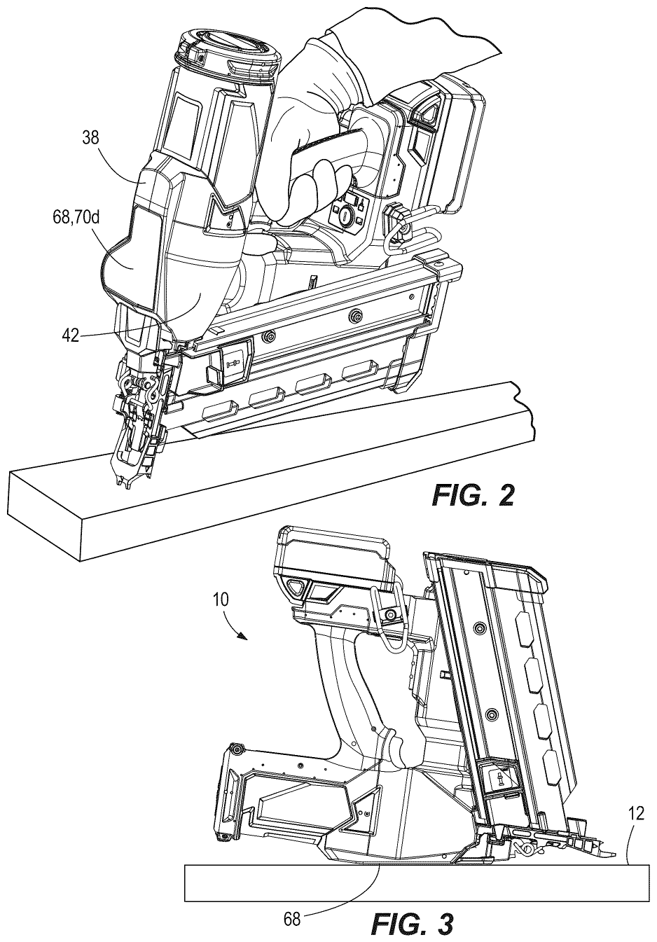

In the illustrated embodiment, the housing 38 includes a flat or planar segment 68 positioned on the second side 42b of the cylinder support portion 42. In the illustrated embodiment, the housing 38 defines a recess 70 having a flat wall 70a and a lip 70b extending about the perimeter of the flat wall 70a. In the illustrated embodiment, the recess 70 may be filled with an overmold portion 70d (FIG. 2). In such case, the overmold portion 70d has a flat surface that defines the flat segment 68. In some embodiments, the flat segment 68 may formed by the material of the housing 38, such that the recess 70 and associated structure (e.g., wall 70a and lip 70b) would be omitted. Regardless, the flat segment 68 is configured to support the fastener driver 10 on a support surface 12 (FIG. 3) in an inverted position, as shown in FIG. 3, with the handle portion 58 extending away from the support surface 12. In the illustrated embodiment, the flat segment 68 extends onto the drive unit support portion 46, as well. As shown, the flat segment 68 is asymmetrical due to the portion that extends onto the drive unit support portion 46. Also, as shown, the flat segment 68 includes a length L and a width W that varies along the length L (FIG. 1A). As shown in FIG. 1B, a plane P defined by the flat segment 68 is positioned at an oblique angle A1 relative to a driving axis 72 along which fasteners are driven.

With reference to FIGS. 4A and 4B, the inner cylinder 18 and the driver blade 26 define the driving axis 72. During a driving cycle, the driver blade 26 and piston 22 are moveable between a top-dead-center (TDC) (i.e., retracted) position and a driven or bottom-dead-center (BDC) (i.e., extended) position. The fastener driver 10 further includes a lifting assembly 74 (FIGS. 4B, 4C, and 5), which is powered by the motor 50, and which is operable to move the driver blade 26 from the BDC position to the TDC position.

In operation, the lifting assembly 74 drives the piston 22 and the driver blade 26 toward the TDC position by energizing the motor 50. In particular, the lifting assembly 74 includes a lifter 78 that has drive pins 82 that are sequentially engageable with teeth (26a, FIG. 4B) of the driver blade 26 to raise the driver blade 26 from the BDC position toward the TDC position. As the piston 22 and the driver blade 26 are driven toward the TDC position, the gas above the piston 22 and the gas within the storage chamber cylinder 30 is compressed. Prior to reaching the TDC position, the motor 50 is deactivated and the piston 22 and the driver blade 26 are held in a ready position, which is located between the TDC and the BDC positions, until being released by user activation of the trigger 66. When released, the compressed gas above the piston 22 and within the storage chamber cylinder 30 drives the piston 22 and the driver blade 26 toward the BDC position, thereby driving a fastener into the workpiece. The illustrated fastener driver 10 therefore operates on a gas spring principle utilizing the lifting assembly 74 and the piston 22 to further compress the gas within the inner cylinder 18 and the storage chamber cylinder 30. Further detail regarding the structure and operation of the fastener driver 10 is provided below.

With reference to FIGS. 4A and 5, the driver 10 further includes a frame 86 positioned within the housing 38. The frame 86 is coupled to one end of the inner cylinder 18. The frame 86 is formed by a plurality of portions 90, 94. The illustrated frame 86 includes a cylinder support portion 90, and a lifter housing portion 94. The cylinder support portion 90 is coupled to the inner cylinder 18 (FIGS. 4A and 4B). In the illustrated embodiment, the cylinder support portion 90 is threadably coupled to an inner surface of the inner cylinder 18 (FIGS. 4A and 4B). The lifter housing portion 94 supports the lifting assembly 74 (FIG. 5).

With reference to FIG. 5, the transmission 54, which raises the driver blade 26 from the BDC position toward the TDC position, is operatively coupled to the motor 50. Accordingly, the motor 50 provides torque to the transmission 54 when activated. The transmission 54 further includes an output shaft 98 (FIG. 4C) extending to the lifter 78 of the lifting assembly 74, which is operable to move the driver blade 26 from the BDC position toward the TDC position. In other words, the transmission 54 provides torque to the lifter 78 from the motor 50. The transmission 54 may be configured as a planetary transmission having a multi-stage planetary transmission including any number of planetary stages (e.g., two planetary stages, three planetary stages, etc.). In alternative embodiments, the transmission 54 may be a single-stage planetary transmission. The output shaft 98 defines a rotational axis 100 (FIG. 5), about which the lifter 78 rotates. The rotational axis 100 intersects the plane P defined by the flat segment 68.

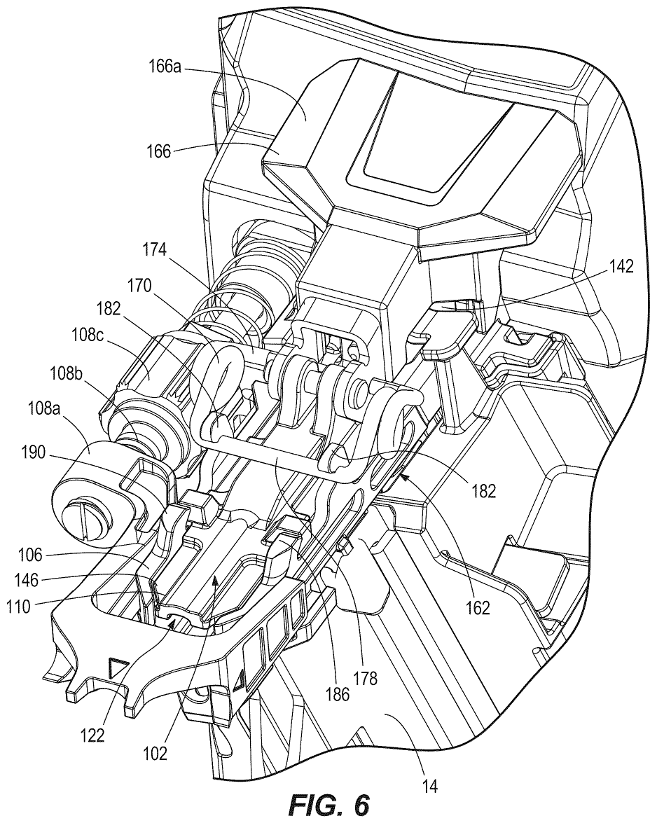

With reference to FIGS. 4A and 6-7, the driver 10 further includes a nosepiece 102 supported by the frame 86. The nosepiece 102 includes a nosepiece base 106 and a nosepiece cover 110 movably coupled to the nosepiece base 106. In the illustrated embodiment, not shown, the nosepiece base 106 is separate and affixed to the frame 86. In the other embodiments, the nosepiece base 106 is integral with the frame 86. The nosepiece base 106 is positioned at a front end (FIG. 4A) of the magazine 14. The nosepiece cover 110 substantially covers the nosepiece base 106 (FIG. 6). In the illustrated embodiment, the nosepiece cover 110 is releasably coupled to the nosepiece base 106 by a latch 162. In other embodiments, the nosepiece cover 110 is completely separate from the nosepiece base 106.

The nosepiece base 106 and the nosepiece cover 110 form a firing channel 122 therebetween (FIG. 4A). The magazine 14 includes a fastener channel (not shown) along a length thereof. The firing channel 122 is in communication with the fastener channel. The firing channel 122 is configured to consecutively receive the fasteners from a collated fastener strip stored in the fastener channel of the magazine 14. The firing channel 122 is aligned with the driving axis 72 of the driver blade 26. With reference to FIGS. 1A and 2, the driver 10 further includes a workpiece contact element 108 supported by the nosepiece 102 (e.g., the nosepiece base 106). The illustrated workpiece contact element 108 includes generally two portions 108a, 108b. The first and second portions 108a, 108b are movably coupled together by a depth of drive adjustment mechanism 108c, which adjusts the effective length of the workpiece contact element 108. The first portion 108a is slidably guided along an outer surface of the nosepiece base 106.

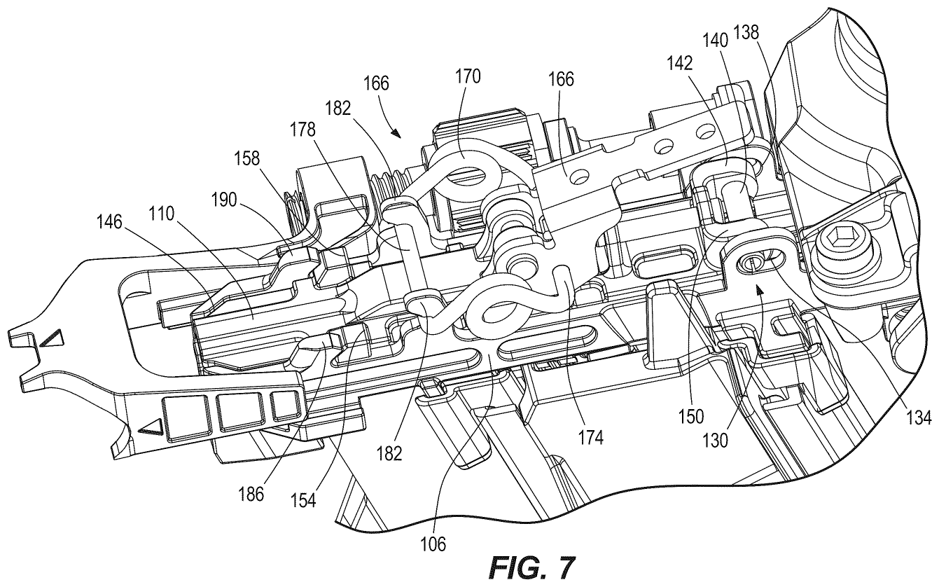

With reference to FIGS. 6-7, the nosepiece cover 110 is movably secured to the nosepiece base 106 by a joint 130 having multiple degrees of freedom. In the illustrated embodiment, the joint 130 is a pivoting and sliding joint 130. In particular, the nosepiece base 106 includes an elongated first guiding slot 134 and an elongated second guiding slot 138. The nosepiece cover 110 is pivotably supported relative to the nosepiece base 106 by an axle or shaft 140. In particular, the shaft 140 is received within the first and second guiding slots 134, 138. In some embodiments, the shaft 140 is integral with the nosepiece cover 110. In other embodiments, the shaft 140 is separate and affixed to the nosepiece cover 110. In addition, the nosepiece cover 110 is slidable relative to the nosepiece base 106 by sliding movement of the shaft within the first and second guiding slots 134, 138. More specifically, the nosepiece cover 110 is slidable in a direction parallel to the driving axis 72.

With reference to FIG. 6, the nosepiece cover 110 extends between a first end 142 and a second end 146. The first end 142 includes a bracket assembly 150 configured to receive the shaft for pivotably coupling the nosepiece cover 110 to the nosepiece base 106. The nosepiece cover 110 also includes a first retaining member 154 and a second retaining member 158 positioned proximate the second end 146 of the nosepiece cover 110. The illustrated first and second retaining members 154, 158 are configured as wedges positioned at opposite lateral edges of the nosepiece cover 110.

If a fastener becomes jammed within the firing channel 122, the nosepiece cover 110 can be pivoted to an open position to clear the jam. The nosepiece cover 110 is secured in a closed position by the latch 162. The latch 162 includes a lever 166 that is pivotable about the nosepiece cover 110 and is configured to be grasped by a user. A portion of the lever is removed for clarity in FIGS. 6 and 7. The latch 162 further includes a spring 170 having a first end 174 connected to the lever 166, and a second end 178 opposite the first end 174. The second end 178 of the spring 170 is received within hooks 182 formed on the nosepiece base 106 for securing the nosepiece cover 110 to the nosepiece base 106, thereby positioning the latch 162 in a latched state (FIG. 6). The latch 162 is adjustable from the latched state to a released state (not shown).

The nosepiece base 106 further includes first and second projections 186, 190 extending therefrom. The first and second retaining members 154, 158 of the nosepiece cover 110 are slidably engageable with the first and second projections 186, 190, respectively. More specifically, the first and second projections 186, 190 have ramped surfaces corresponding to ramped surfaces of the first and second retaining members 154, 158, respectively. Engagement between the first and second retaining members 154, 158 and the first and second projections 186, 190, respectively, is configured to selectively inhibit pivoting movement of the nosepiece cover 110 relative to the nosepiece base 106 until the retaining members 154, 158 are moved (i.e., slid) completely out of the way of the projections 186, 190.

To secure the nosepiece cover 110 in the closed position, the nosepiece cover 110 is slidably moved relative to the nosepiece base 106 in a first direction (e.g., to the left from the frame of reference of FIG. 6), such that the shaft also moves in the first direction within the first and second guiding slots 134, 138, until the first and second retaining members 154, 158 are completely engaged with the first and second projections 186, 190, respectively, and the second end 178 of the spring 170 is engaged with the hooks 182 of the nosepiece base 106, thereby adjusting the latch 162 into the latched state. To release the nosepiece cover 110, the lever 166 is rotated away from the nosepiece cover 110 (FIG. 7), releasing the second end 178 of the spring 170 from engagement with the hooks 182, thereby adjusting the latch 162 from the latched state to the released state. Subsequently, the nosepiece cover 110 is slidably moved by a user in a second, opposite direction (e.g., to the right from the frame of reference of FIG. 7) such that the shaft 140 within the first and second guiding slots 134, 138 is also moved in the second direction until the first and second retaining members 154, 158 are moved completely out of engagement with the first and second projections 186, 190, respectively. A user then pivots the nosepiece cover 110 away from the nosepiece base 106 by the shaft 140 toward the open position.

As shown in FIGS. 1B, 4A, and 6, the lever 166 has a planar surface 166a that is co-planar with the flat segment 68. Moreover, as shown, a height of the planar surface 166a of the lever 166 is greater than a height of an outermost surface of the nosepiece cover 110 on the first side and also an outermost surface of workpiece contact element 108. Accordingly, the lever 166 and the flat segment 68, in tandem, support the fastener driver 10 in the inverted position while preventing the nosepiece 102 and/or the workpiece contact element 108 from contacting the support surface 12 (FIG. 3). In other words, when in the inverted position, the nosepiece 102 and/or the workpiece contact element 108 are still spaced apart from the support surface.

Although the invention has been described in detail with reference to certain preferred embodiments, variations and modifications exist within the scope and spirit of one or more independent aspects of the invention as described.

What is claimed is:

1. A powered fastener driver comprising:
a housing defining a cylinder support portion and a handle portion, the cylinder support portion including a first side and a second side opposite the first side, the handle portion extending from the first side of the cylinder support portion, the cylinder support portion including a flat segment on the second side configured to support the powered fastener driver on a support surface in an inverted position with the handle portion extending away from the support surface;
a cylinder within the cylinder support portion;
a nosepiece extending from the housing and including a fastener driving channel through which consecutive fasteners are driven, the fastener driving channel extending along a driving axis; and
a magazine coupled to the nosepiece and configured to consecutively deliver the fasteners to the fastener driving channel.

2. The powered fastener driver of claim 1, wherein the housing includes an overmold portion defining the flat segment.

3. The powered fastener driver of claim 1, wherein the nosepiece includes a nosepiece base and a nosepiece cover defining the fastener driving channel therebetween, and wherein the nosepiece cover is movable relative to the nosepiece base between a closed position and an open position.

4. The powered fastener driver of claim 3, further comprising:
a latch mechanism releasably coupling the nosepiece cover to the nosepiece base, the latch mechanism adjustable between a latched state and a released state,
wherein the latch mechanism is adjustable from the latched state to the released state prior to adjustment of the nosepiece cover from the closed position to the open position, and
wherein, when the latch mechanism is in the released state, the nosepiece cover is pivotable relative to the nosepiece base.

5. The powered fastener driver of claim 4, wherein the latch mechanism includes a lever with a planar surface that is co-planar with the flat segment.

6. The powered fastener driver of claim 3, further comprising:
latch mechanism releasably coupling the nosepiece cover to the nosepiece base, the latch mechanism adjustable between a latched state and a released state,
wherein the latch mechanism is adjustable from the latched state to the released state prior to adjustment of the nosepiece cover from the closed position to the open position,
wherein, when the latch mechanism is in the released state, the nosepiece cover is movable relative to the nosepiece base in a direction parallel with the driving axis, and
wherein, when the latch mechanism is in the released state, the nosepiece cover is pivotable relative to the nosepiece base.

7. The powered fastener driver of claim 6, wherein the latch mechanism includes a lever with a planar surface that is co-planar with the flat segment.

8. The powered fastener driver of claim 1, wherein a plane defined by the flat segment is positioned at an oblique angle relative to the driving axis.

9. The powered fastener driver of claim 1, further comprising:
a moveable piston positioned within the cylinder;
a driver blade attached to the piston and movable therewith between a top-dead-center (TDC) position and a bottom-dead-center (BDC) position;
a lifter operable to move the driver blade from the BDC position toward TDC position; and
a transmission including an output shaft for providing torque to the lifter, the output shaft defines a rotational axis about which the lifter rotates,
wherein the rotational axis intersects the flat segment.

10. A powered fastener driver comprising:
a housing defining a cylinder support portion and a handle portion, the cylinder support portion including a first side and a second side opposite the first side, the handle portion extending from the first side of the cylinder support portion;
a cylinder within the cylinder support portion;
a nosepiece extending from the housing and including a fastener driving channel through which consecutive fasteners are driven, the fastener driving channel extending along a driving axis, the nosepiece including
a nosepiece base, and
a nosepiece cover defining the fastener driving channel therebetween, wherein the nosepiece cover is movable relative to the nosepiece base between a closed position and an open position;
a latch mechanism releasably coupling the nosepiece cover to the nosepiece base, the latch mechanism adjustable between a latched state and a released state; and
a magazine coupled to the nosepiece and configured to consecutively deliver the fasteners to the fastener driving channel,
wherein a portion of the second side of the housing and a portion of the latch mechanism collectively define a planar surface that is configured to support the powered fastener driver on a support surface in an inverted position with the handle portion extending away from the support surface.

11. The powered fastener driver of claim 10, wherein the housing includes an overmold portion defining the portion of the second side of the housing.

12. The powered fastener driver of claim 10, wherein
the latch mechanism is adjustable from the latched state to the released state prior to adjustment of the nosepiece cover from the closed position to the open position, and
when the latch mechanism is in the released state, the nosepiece cover is pivotable relative to the nosepiece base.

13. The powered fastener driver of claim 12, wherein the latch mechanism includes a lever that includes the portion of the latch mechanism.

14. The powered fastener driver of claim 10, wherein
the latch mechanism is adjustable from the latched state to the released state prior to adjustment of the nosepiece cover from the closed position to the open position,
when the latch mechanism is in the released state, the nosepiece cover is movable relative to the nosepiece base in a direction parallel with the driving axis, and
when the latch mechanism is in the released state, the nosepiece cover is pivotable relative to the nosepiece base.

15. The powered fastener driver of claim 14, wherein the latch mechanism includes a lever that includes the portion of the latch mechanism.

16. A powered fastener driver comprising:
a housing defining a cylinder support portion and a handle portion, the cylinder support portion including a first side and a second side opposite the first side, the handle portion extending from the first side of the cylinder support portion, the cylinder support portion including a planar surface on the second side configured to support the powered fastener driver on a support surface in an inverted position with the handle portion extending away from the support surface;
a cylinder within the cylinder support portion;
a nosepiece extending from the housing and including a fastener driving channel through which consecutive fasteners are driven, the fastener driving channel extending along a driving axis; and
a magazine coupled to the nosepiece and configured to consecutively deliver the fasteners to the fastener driving channel,
wherein a plane defined by the planar surface is positioned at an oblique angle relative to the driving axis.

17. The powered fastener driver of claim 16, wherein the nosepiece includes a nosepiece base and a nosepiece cover defining the fastener driving channel therebetween, and wherein the nosepiece cover is movable relative to the nosepiece base between a closed position and an open position.

18. The powered fastener driver of claim 17, further comprising:
a latch mechanism releasably coupling the nosepiece cover to the nosepiece base, the latch mechanism adjustable between a latched state and a released state,
wherein the latch mechanism is adjustable from the latched state to the released state prior to adjustment of the nosepiece cover from the closed position to the open position, and
wherein, when the latch mechanism is in the released state, the nosepiece cover is pivotable relative to the nosepiece base.

19. The powered fastener driver of claim 18, wherein the latch mechanism includes a lever with a planar surface that is co-planar with the planar surface of the housing.

20. The powered fastener driver of claim 16, further comprising:
a moveable piston positioned within the cylinder;
a driver blade attached to the piston and movable therewith between a top-dead-center (TDC) position and a bottom-dead-center (BDC) position;
a lifter operable to move the driver blade from the BDC position toward TDC position; and
a transmission including an output shaft for providing torque to the lifter, the output shaft defines a rotational axis about which the lifter rotates,
wherein the rotational axis intersects the plane.
